(19) United States
(12) Patent Application Publication
(10) Pub. No.: US 2023/0203844 A1
(43) Pub. Date: Jun. 29, 2023

(54) SMART DOOR LOCK ASSEMBLY, CLUTCH CONTROL METHOD OF SMART DOOR LOCK ASSEMBLY, AND SMART DOOR LOCK

(71) Applicant: SHENZHEN FINGERCHIP IOT TECHNOLOGY CO., LTD, Shenzhen (CN)

(72) Inventors: MINGHUA XIONG, Shenzhen (CN); Haiping YI, Shenzhen (CN); Jun YU, Shenzhen (CN)

(21) Appl. No.: 17/676,259

(22) Filed: Feb. 21, 2022

(30) Foreign Application Priority Data
Dec. 23, 2021 (CN) 2021115899481

(51) Int. Cl. E05B 47/00; E05B 63/00

(52) U.S. Cl. CPC E05B 47/0012; E05B 63/0017; E05B 2047/0017; E05B 2047/002; E05B 2047/0026; E05B 2047/0067

(57) ABSTRACT

A smart door lock assembly includes a lock cylinder, a lock cylinder mounting block, a driving motor, and a driving control board. A driving gear is arranged on a movable end of the driving motor. The lock cylinder passes through and is mounted in the lock cylinder mounting block. A driven gear coaxial with the lock cylinder is arranged on the lock cylinder mounting block. The driven gear is driven by the driving gear. The driving control board determines whether an external input unlocking command is right and controls the driving motor to unlock the smart door lock assembly when the external input unlocking command is right. The driving motor has a virtual position in a process of driving the driving gear.

### TECHNICAL FIELD

The present disclosure relates to a field of smart lock technology, and in particular to a smart door lock assembly, a clutch control method of the smart door lock assembly, and a smart door lock.

### BACKGROUND

With improvement of people's living standards, smart door locks opened by fingerprints, passwords, mechanical keys, applications, and other methods become popular.

However, the conventional smart door locks have following problems: a clutch structure of a lock body usually adopts a linear structure, which is realized by axial clutch of a lock cylinder and a driving portion. This kind of clutch structure has many instability. As a result, the lock body needs to reserve enough axial allowance, a driving torque of the lock cylinder is relatively small, reliability is poor, and service life is short.

### SUMMARY

Technical problems to be solved by the present disclosure is to provide a smart door lock assembly, a clutch control method of the smart door lock assembly, and a smart door lock in view of the above-mentioned defects of the prior art.

The present disclosure provides a smart door lock assembly. The smart door lock assembly comprises a lock cylinder, a lock cylinder mounting block, a driving motor, and a driving control board. A driving gear is arranged on a movable end of the driving motor. The lock cylinder passes through the lock cylinder mounting block and is mounted in the lock cylinder mounting block. A driven gear coaxial with the lock cylinder is arranged on the lock cylinder mounting block. The driven gear is driven by the driving gear. The driving control board determines whether an external input unlocking command is right and controls the driving motor to unlock the smart door lock assembly when the external input unlocking command is right. The driving motor has a virtual position in a process of driving the driving gear.

In the smart door lock assembly of the present disclosure, the smart door lock assembly further comprises an induction circuit board. An induction sheet is arranged on the lock cylinder mounting block. The induction circuit board comprises a first detecting unit, a second detecting unit, and a third detecting unit. The first detecting unit, the second detecting unit, and the third detecting unit are configured to detect a position of the induction sheet. The second detecting unit and the third detecting unit are respectively arranged on two sides of the first detecting unit. The driving control board controls an unlocking rotation direction of the driving motor according to sensing data of the induction circuit board.

In the smart door lock assembly of the present disclosure, a groove is provided on one side of the lock cylinder mounting block facing the induction circuit board. The groove is circular. A bottom portion of the groove defines an opening. The lock cylinder passes through the opening. Two positioning blocks are arranged in the groove. Elastic pieces are arranged between the two positioning blocks. A positioning convex block is arranged on an outer side of each of the two positioning blocks. Positioning grooves matched with the positioning convex blocks are provided on an inner wall of the groove. The lock cylinder comprises straight sections. Limit key grooves matched with the straight sections are arranged on the two positioning blocks.

In the smart door lock assembly of the present disclosure, a mounting piece is fixedly connected to the lock cylinder, the induction sheet is arranged on the mounting piece. The mounting piece covers the groove.

In the smart door lock assembly of the present disclosure, the elastic piece are springs and are arranged on two sides of the lock cylinder. The two positioning blocks are provided with spring positioning grooves configured to position the springs. A spring positioning block extending into a corresponding spring is arranged on each of the positioning grooves.

In the smart door lock assembly of the present disclosure, a bearing and a mounting groove configured to mount the bearing are arranged on one side of the lock cylinder mounting block away from the induction circuit board. A manual knob is connected with one end of the lock cylinder.

In the smart door lock assembly of the present disclosure, both of the driving gear and the driven gear are bevel gears.

In the smart door lock assembly of the present disclosure, the smart door lock assembly further comprises a lock body, a lock panel, and a rear lock shell. The lock cylinder rotates to unlock the lock body. The lock cylinder mounting block, the driving motor, and the induction circuit board are arranged on the rear lock shell. The driving control board is arranged on the lock panel.

The present disclosure provides a clutch control method of a smart door lock assembly, which is applied to the above mentioned smart door lock assembly. The clutch control method of a smart door lock assembly comprises steps:

recognizing and determining whether the external input unlocking command is right, by the driving control board, after receiving the external input unlocking command;

doing not respond, by the driving control board, if the driving control board determined that the external input unlocking command is wrong; controlling the driving motor to run to drive the lock cylinder to rotate to unlock the smart door lock assembly, if the driving control board determined that the eternal input unlocking command is right; and

controlling the driving motor to reversely rotate by a predetermined angle by the driving control board after the smart door lock assembly is unlocked to make the driving gear to be located at a non-end position of the virtual position.

The present disclosure provides a smart door lock. The smart door lock comprises the above mentioned smart door lock assembly.

The smart door lock of the present disclosure adopts the driving motor with a virtual position, and drives the lock cylinder by means of gear transmission, which has good structural reliability and transmits a high unlocking torque. The smart door lock assembly is unlocked by a key or the manual knob located indoors when the lock cylinder is driven to rotate in place and the driving motor is rotated to the non-end positions of the virtual position, which have no resistance of the gears, do not have abnormal noise. A clutch structure is very simple, and an overall structure is reasonable and extremely compact.

### BRIEF DESCRIPTION OF DRAWINGS

In order to clearly illustrate embodiments of the present disclosure or technical solutions in the prior art, the present disclosure will be further described below with reference to the accompanying drawings and embodiments. For those of ordinary skill in the art, under premise of no creative work, other drawings are able to be obtained from these drawings.

FIG. 1 is a structural schematic diagram of a smart door lock assembly according to one optional embodiment of the present disclosure.

FIG. 2 is an exploded schematic diagram of the smart door lock assembly according to one optional embodiment of the present disclosure.

FIG. 3 is an exploded schematic diagram of a rear lock shell of the smart door lock assembly according to one optional embodiment of the present disclosure.

FIG. 4 is another exploded schematic diagram of a rear lock shell of the smart door lock assembly according to one optional embodiment of the present disclosure.

FIG. 5 is an exploded schematic diagram of a manual knob, a lock cylinder, a lock cylinder mounting block, a driving motor, and an induction circuit board according to one optional embodiment of the present disclosure.

FIG. 6 is another exploded schematic diagram of the manual knob, the lock cylinder, the lock cylinder mounting block, the driving motor, and the induction circuit board according to one optional embodiment of the present disclosure.

FIG. 7 is a schematic diagram showing transmission between the driving motor and the lock cylinder mounting block of the smart door lock assembly according to one optional embodiment of the present disclosure (springs arranged on an upper portion are not shown).

FIG. 8 is a schematic diagram of the positioning blocks of the smart door lock assembly according to one optional embodiment of the present disclosure (the springs arranged on the upper portion are not shown).

FIG. 9 is a schematic diagram showing cooperation between a cam and a cam groove of the smart door lock assembly according to one optional embodiment of the present disclosure.

FIG. 10 is a flow chart of a clutch control method of the smart door lock assembly according to one optional embodiment of the present disclosure.

### DETAILED DESCRIPTION

In order to make purposes, technical solutions, and advantages of the embodiments of the present disclosure clear, the following will describe the technical solutions in the embodiments of the present disclosure clearly and completely. Obviously, the described embodiments are only parts of the embodiments of the present disclosure, and are not all of the embodiments. Based on the embodiments of the present disclosure, all other embodiments obtained by those of ordinary skill in the art without creative work should fall within the protection scope of the present disclosure.

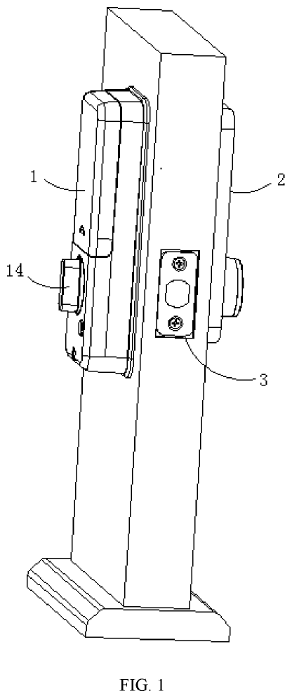

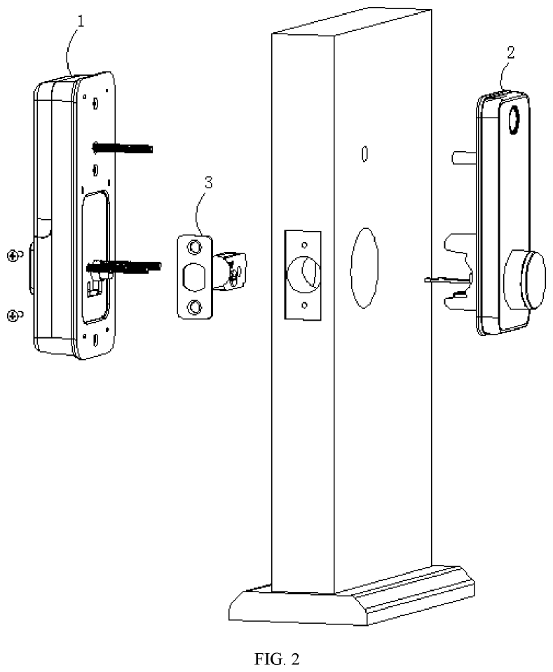

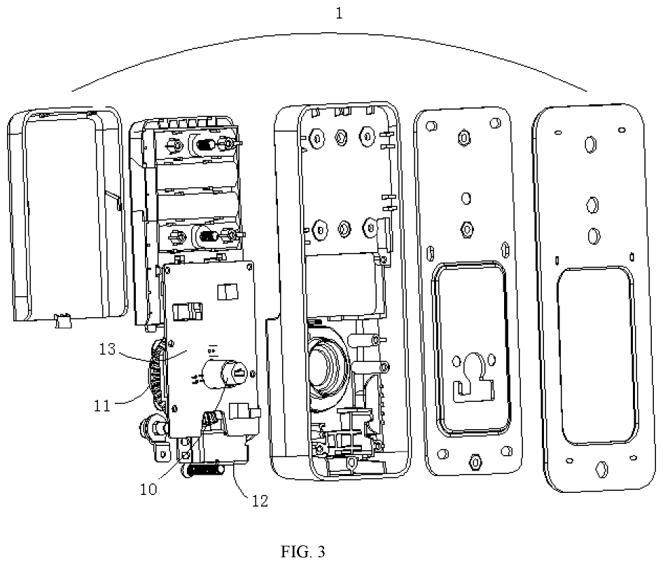

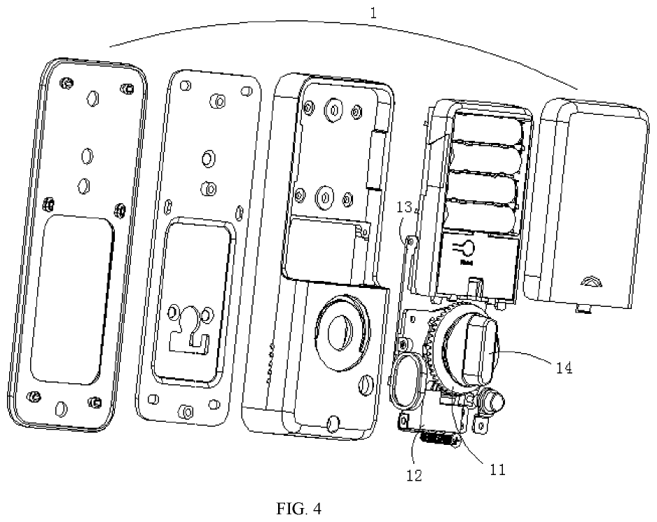

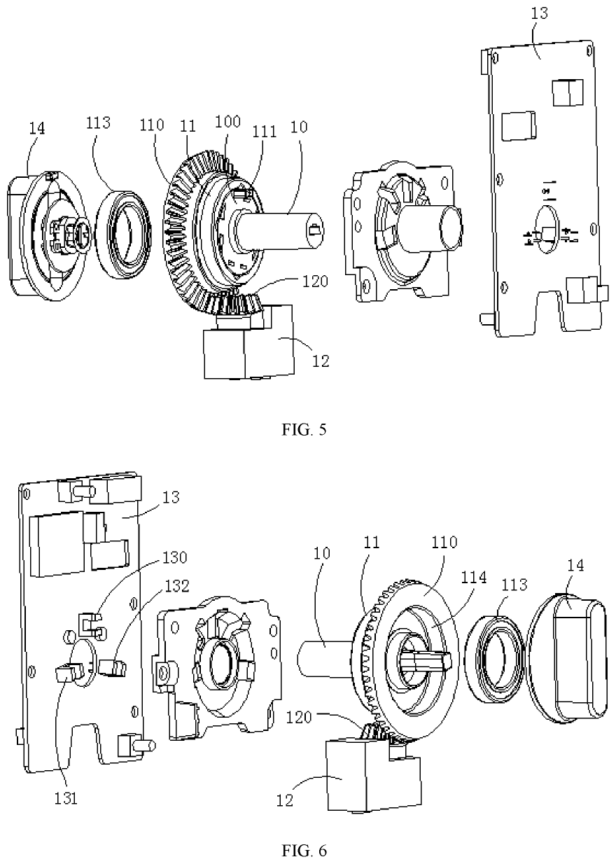

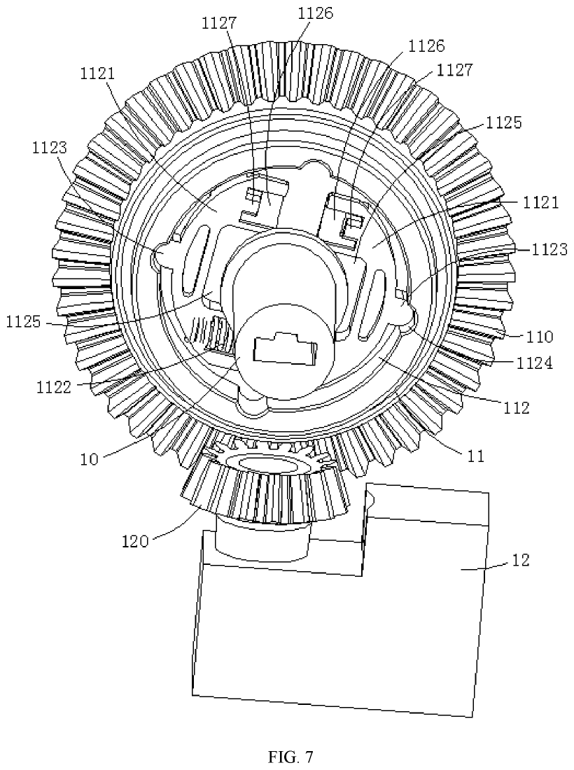

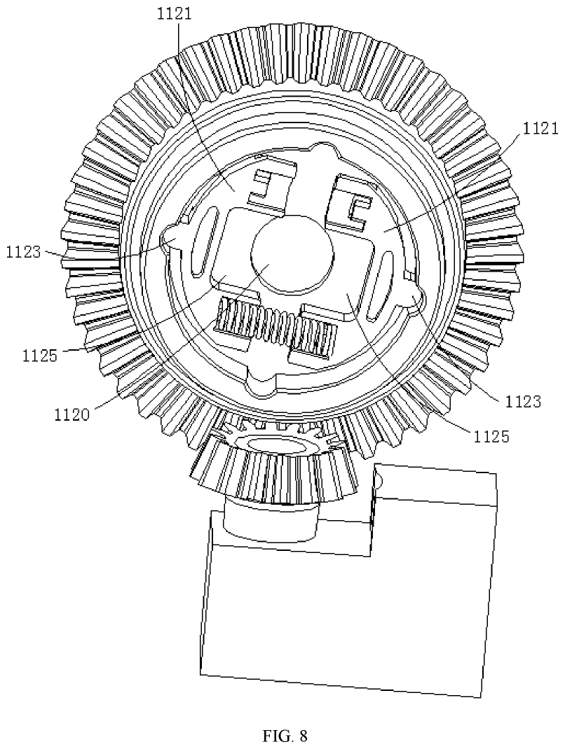

As shown in FIGS. 1-9, in one optional embodiment of the present disclosure, a smart door lock assembly is provided. The smart door lock assembly comprises a lock cylinder 10, a lock cylinder mounting block 11, a driving motor 12, and a driving control board 20. A driving gear 120 is arranged on a movable end of the driving motor 12. The lock cylinder 10 passes through and is mounted in the lock cylinder mounting block 11. A driven gear 110 coaxial with the lock cylinder 10 is arranged on the lock cylinder mounting block 11. The driven gear 110 is driven by the driving gear 120. The driving control board 20 determines whether an external input unlocking command is right and controls the driving motor 12 to unlock the smart door lock assembly when the external input unlocking command is right. The driving motor 12 has a virtual position in a process of driving the driving gear 120.

The smart door lock of the present disclosure adopts the driving motor 12 with the virtual position, and drives the lock cylinder by means of gear transmission, which has good structural reliability and transmits a high unlocking torque. The smart door lock assembly is unlocked by a key or a manual knob located indoors when the lock cylinder 10 is driven to rotate in place and the driving motor 12 is rotated to the non-end positions of the virtual position, which have no resistance of the gears, do not have abnormal noise. A clutch structure is very simple, and an overall structure is reasonable and extremely compact.

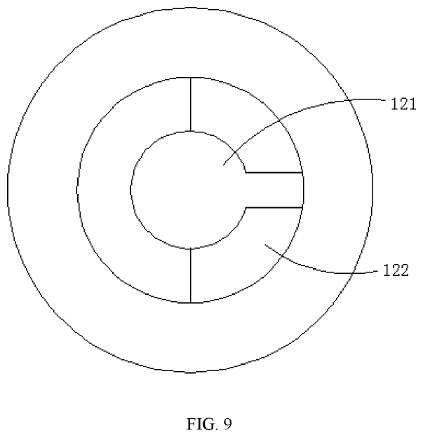

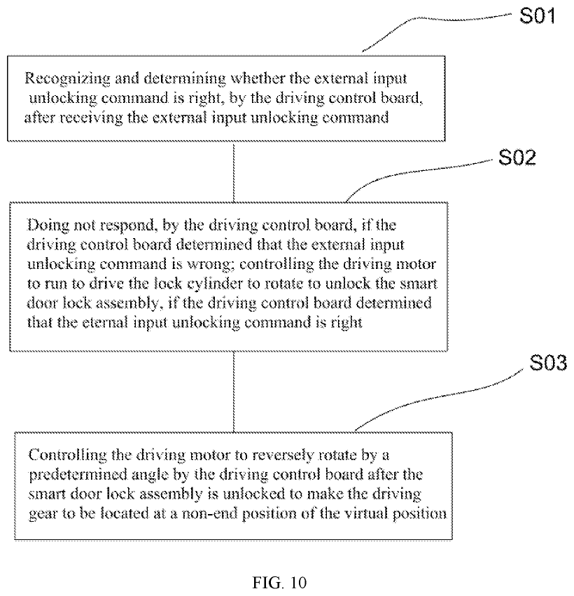

Optionally, the virtual position is defined by a cam 121 shown in FIG. 9 and a virtual position groove 122 matched with a convex portion of the cam 121, where the virtual position groove 122 may be arranged on the driving gear, or arranged on a transmission piece driving the driving gear to rotate. Driving of the virtual position of the driving gear is realized by a neutral position in which the convex portion of the cam 121 runs in the virtual position groove 122. Of course, the virtual position can also adopt other existing virtual position setting methods, and any simple replacement based on the principle falls within the protection scope of the present disclosure. A central angle of the virtual position groove 122 can be adaptively set according to the actual required virtual position angle;

Optionally, in order to obtain a large output torque, the driving motor is a deceleration motor.

Optionally, the smart door lock assembly further comprises an induction circuit board 13. An induction sheet 111 is arranged on the lock cylinder mounting block 11. The induction circuit board 13 comprises a first detecting unit 130, a second detecting unit 131, and a third detecting unit 132. The first detecting unit 130, the second detecting unit 131, and the third detecting unit 132 are configured to detect a position of the induction sheet 111. The second detecting unit 131 and the third detecting unit 132 are respectively arranged on two sides of the first detecting unit 130. The driving control board 20 controls an unlocking rotation direction of the driving motor 12 according to sensing data of the induction circuit board 20.

In an initial state, the induction sheet 111 is arranged at a position of the first detecting unit 130. After a system of the smart door lock assembly is started, it controls the driving motor 12 to rotate to the left and right by the predetermined angle, respectively. If the second detecting unit 131 detects a reading and the third detecting unit 132 does not detect a reading, it is determined that a rotation direction toward the second detecting unit 131 is positive. If the third detecting unit 132 detects the reading and the second detecting unit 131 does not detect the reading, it is determined that a rotation direction toward the third detecting unit 132 is positive. If the second detecting unit 131 and the third detecting unit 132 do not detect the readings, it is determined that the smart door lock assembly is faulty; and a door opening direction is automatically recognized, adjusted and memorized, which greatly improves adaptability and is convenient to operate at the same time, greatly enhances market competitiveness.

Optionally, a groove 112 is provided on one side of the lock cylinder mounting block 11 facing the induction circuit board 13. The groove 112 is circular. A bottom portion of the groove 112 defines an opening 1120. The lock cylinder 10 passes through the opening 1120. Two positioning blocks 1121 are arranged in the groove 112. Elastic pieces 1122 are arranged between the two positioning blocks 1121. A positioning convex block 1123 is arranged on an outer side of each of the two positioning blocks 1121. Positioning grooves 1124 matched with the positioning convex blocks 1123 are provided on an inner wall of the groove 112. The lock cylinder 10 comprises straight sections. Limit key grooves 1125 matched with the straight sections are arranged on the two positioning blocks 1121.

Through cooperation between the limit key grooves 1125 and the straight sections on the lock cylinder 10 (Optionally, the straight sections are square, or upper and lower surfaces of the straight sections are flat and two side surfaces of the straight sections are arcuate), and through elastic force of the elastic pieces 1122 in a normal state, when unlocking the smart door lock assembly, the positioning convex blocks 1123 abut against the positioning grooves 1124, so that the driven gear 110 drives the lock cylinder 10 to rotate through the two positioning blocks 1121 while driving the lock cylinder mounting block 11 to rotate to unlock the smart door lock assembly.

However, various transmission components arranged in a lock body have the probability of damage and have certain service life. When an unexpected situation occurs and the smart door lock assembly is unable to be unlocked, a user is able to twist the lock cylinder 10 violently from the indoor room to make the two positioning convex blocks 1123 to rotate. Then, two positioning convex blocks 1123 overcome the elastic force of the elastic pieces and disengage from the positioning grooves 1124.

Thus, in an emergency, the user is able to unlock the door from indoors, which improves security.

Optionally, a mounting piece 100 is fixedly connected to the lock cylinder 10. The induction sheet 111 is arranged on the mounting piece 100. The mounting piece 100 covers the groove 112, therefore, mounting integrity is good, and the reliability is good.

Optionally, the elastic piece 1122 are springs and are arranged on two sides of the lock cylinder 10. The two positioning blocks 1121 are provided with spring positioning grooves 1126 configured to position the springs. A spring positioning block 1127 extending into a corresponding spring is arranged on each of the positioning grooves 1126. The assembly of the smart door lock assembly is convenient, the stability is good, and the springs are not easy to shift.

Optionally, a bearing 113 and a mounting groove 114 configured to mount the bearing 113 are arranged on one side of the lock cylinder mounting block 11 away from the induction circuit board 13. A manual knob 14 is connected with one end of the lock cylinder 10. Therefore, the smart door lock assembly is convenient to operate, simple to install, extremely compact in structure, and high in space utilization, which is beneficial for reducing an overall volume of the smart door lock assembly.

Optionally, both of the driving gear 120 and the driven gear 110 are bevel gears.

Optionally, the smart door lock assembly further comprises a lock body 3, a lock panel 2, and a rear lock shell 1. The lock cylinder 10 rotates to unlock the lock body 3. The lock cylinder mounting block 11, the driving motor 12, and the induction circuit board 13 are arranged on the rear lock shell 1. The driving control board 20 is arranged on the lock panel 2. Therefore, the intelligent door lock assembly is simple in structure, convenient in operation, reasonable in structure and compact in structure.

Optionally, a battery compartment, a battery and a common control button assembly are arranged on the rear lock shell. A fingerprint identification panel, a camera, and other component are arranged on the lock panel.

The present disclosure provides a clutch control method of a smart door lock assembly, which is applied to the above mentioned smart door lock assembly. The clutch control method of the smart door lock assembly comprises steps:

S01: recognizing and determining whether the external input unlocking command is right, by the driving control board, after receiving the external input unlocking command;

S02: doing not respond, by the driving control board, if the driving control board determined that the external input unlocking command is wrong; controlling the driving motor to run to drive the lock cylinder to rotate to unlock the smart door lock assembly, if the driving control board determined that the eternal input unlocking command is right; and

S03: controlling the driving motor to reversely rotate by a predetermined angle by the driving control board after the smart door lock assembly is unlocked to make the driving gear to be located at a non-end position of the virtual position.

The present disclosure adopts the driving motor 12 with the virtual position, and drives the lock cylinder by means of gear transmission, which has good structural reliability and transmits the high unlocking torque. The smart door lock assembly is unlocked by the key or the manual knob located indoors when the lock cylinder 10 is driven to rotate in place and the driving motor 12 is rotated to the non-end positions of the virtual position, which have no resistance of the gears and do not have abnormal noise. The clutch structure is very simple, and the overall structure is reasonable and extremely compact.

The present disclosure provides a smart door lock. The smart door lock comprises the above mentioned smart door lock assembly.

It should be understood that, for those skilled in the art, improvements or changes can be made according to the above description, and all these improvements and changes should fall within the protection scope of the appended claims of the present disclosure.

What is claimed is:

1. A smart door lock assembly, comprising: a lock cylinder, a lock cylinder mounting block, a driving motor, and a driving control board; a driving gear is arranged on a movable end of the driving motor; the lock cylinder passes through the lock cylinder mounting block and is mounted in the lock cylinder mounting block; a driven gear coaxial with the lock cylinder is arranged on the lock cylinder mounting block; the driven gear is driven by the driving gear; the driving control board determines whether an external input unlocking command is right and controls the driving motor to unlock the smart door lock assembly when the external input unlocking command is right; the driving motor has a virtual position in a process of driving the driving gear.

2. The smart door lock assembly according to claim 1, wherein the smart door lock assembly further comprises an induction circuit board; an induction sheet is arranged on the lock cylinder mounting block; the induction circuit board comprises a first detecting unit, a second detecting unit, and a third detecting unit; the first detecting unit, the second detecting unit, and the third detecting unit are configured to detect a position of the induction sheet; the second detecting unit and the third detecting unit are respectively arranged on two sides of the first detecting unit; the driving control board controls an unlocking rotation direction of the driving motor according to sensing data of the induction circuit board.

3. The smart door lock assembly according to claim 2, wherein a groove is provided on one side of the lock cylinder mounting block facing the induction circuit board; the groove is circular; a bottom portion of the groove defines an opening; the lock cylinder passes through the opening; two positioning blocks are arranged in the groove; elastic pieces are arranged between the two positioning blocks; a positioning convex block is arranged on an outer side of each of the two positioning blocks; positioning grooves matched with the positioning convex blocks are provided on an inner wall of the groove; the lock cylinder comprises straight sections; limit key grooves matched with the straight sections are arranged on the two positioning blocks.

4. The smart door lock assembly according to claim 3, wherein a mounting piece is fixedly connected to the lock cylinder; the induction sheet is arranged on the mounting piece; the mounting piece covers the groove.

5. The smart door lock assembly according to claim 3, wherein the elastic piece are springs and are arranged on two sides of the lock cylinder; the two positioning blocks are provided with spring positioning grooves configured to position the springs; a spring positioning block extending into a corresponding spring is arranged on each of the positioning grooves.

6. The smart door lock assembly according to claim 2, wherein a bearing and a mounting groove configured to mount the bearing are arranged on one side of the lock cylinder mounting block away from the induction circuit board; a manual knob is connected with one end of the lock cylinder.

7. The smart door lock assembly according to claim 1, wherein both of the driving gear and the driven gear are bevel gears.

8. The smart door lock assembly according to claim 1, wherein the smart door lock assembly further comprises a lock body, a lock panel, and a rear lock shell; the lock cylinder rotates to unlock the lock body; the lock cylinder mounting block, the driving motor, and the induction circuit board are arranged on the rear lock shell; the driving control board is arranged on the lock panel.

9. A clutch control method for a smart door lock assembly, applied to the smart door lock assembly according to claim 1, comprising:
recognizing and determining whether the external input unlocking command is right, by the driving control board, after receiving the external input unlocking command;
doing not respond, by the driving control board, if the driving control board determined that the external input unlocking command is wrong; controlling the driving motor to run to drive the lock cylinder to rotate to unlock the smart door lock assembly, if the driving control board determined that the eternal input unlocking command is right; and
controlling the driving motor to reversely rotate by a predetermined angle by the driving control board after the smart door lock assembly is unlocked to make the driving gear to be located at a non-end position of the virtual position.

10. A smart door lock, comprising the smart door lock assembly according to claim 1.
